(19) United States
(12) Patent Application Publication
(10) Pub. No.: US 2008/0244840 A1
(43) Pub. Date: Oct. 9, 2008

(54) PROCESS FOR MODIFYING ARAMID FIBERS AND PROCESS FOR DYEING SAID FIBERS

(75) Inventors: Olivier RACCURT, Chelieu (FR); Bocar Noel Diop, Lyon (FR); Sephane Roux, Villeurbanne (FR); Olivier Tillement, Fontaine Saint Martin (FR)

Correspondence Address: OBLON, SPIVAK, MCCLELLAND MAIER & NEUSTADT, P.C., 1940 DUKE STREET, ALEXANDRIA, VA, 22314, US

(73) Assignees: COMMISSARIAT A L'ENERGIE ATOMIQUE, Paris (FR); UNIVERSITE CLAUDE BERNARD LYON 1, Villeurbanne (FR); CENTRE NATIONAL DE LA RECHERCHE SCIENTIFIQUE, Paris (FR)

(21) Appl. No.: 12/061,220

(22) Filed: Apr. 2, 2008

(30) Foreign Application Priority Data
Apr. 3, 2007 (FR) 07 54244

(51) Int. Cl. C09B 67/00

(52) U.S. Cl. 8/581; 8/607; 8/608; 8/611; 8/602; 8/587

(57) ABSTRACT

This invention relates to a process for modifying aramid fibers so as to improve their capacity to be dyed, including the following steps:
a) a step of treating said fibers so as to reduce the glass transition temperature Tg thereof to a value Tg₁, in which Tg₁ is lower than Tg;
b) a step of contacting said fibers thus treated with a solution including nanoparticles at a temperature above or equal to Tg₁.

### TECHNICAL FIELD

This invention relates to a process for modifying aramid fibers, so as to facilitate or generate the coloring thereof.

The general field of the invention is therefore that of aramid fibers.

### PRIOR ART

Aramid fibers belong to the family of synthetic fibers, and their common names are Nomex®, Kevlar® and Kermel®.

From a structural perspective, aramid fibers include a synthetic polyamide chain, in which at least 85% of the amide groups are directly bound to aromatic groups, of which the main repetitive pattern has the following formula:

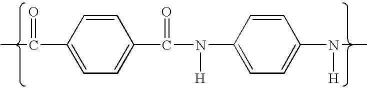

Derivative forms of this pattern may exist with substitutions on the aromatic cycles and a substitution of the hydrogen of the —NH— group.

These fibers have a high mechanical strength and heat resistance as well as flameproof properties. They are therefore widely used as textile fibers intended to be in contact with fire or with high temperatures, in particular in the design of clothing for firefighters, astronauts and pilots.

Aramid fibers have a yellow color in their natural state. They may therefore be subjected to a dyeing process in order to give them a color different from that of their natural state.

The current dyeing processes can be classified into two types:

a) dyeing processes consisting of dyeing the bulk polymer in the form of fibers during synthesis thereof, thus making it possible to color the fibers in bulk as they are synthesized;

b) dyeing processes consisting of dyeing the fibers once synthesized, or even once woven.

Type a) is nevertheless being abandoned by industries in favor of type b), insofar as type a) does not allow the flexibility and reactivity of dyeing on fabric.

Numerous publications describe dyeing processes of type b).

Thus, document EP 0557734 [1] describes a process for dyeing aramid fibers consisting of placing said fibers in contact with a dye having a molecular weight of 400 or lower and having a spectral transmission coefficient of 20% or lower, with an adjustment of the pH to a value of 4 to 5 by adding acetic acid.

Document CA 2 428 758 [2] describes a dyeing process consisting of placing aramid fibers in contact with a composition including a cationic dye and a cyclohexane-type coloring agent. This composition has the special feature of allowing the aramid fibers to swell and of incorporating dyes in the free spaces created by the increase in volume. Nevertheless, the only dyes capable of bonding in these spaces are dyes having a chemical affinity with aramid fibers, which dyes are generally cationic dyes.

Other authors propose modifying the chemical structure of aramid fibers in the synthesis thereof, so as to make these fibers more compatible with the dyes, in particular basic dyes.

Thus, GB 1 221 493 [3] describes a process for modifying linear polyamides, such as aramid, including a free end —NH₂, consisting of reacting a triazine compound with these polyamides by heating, which compound, once grafted onto the polyamide, gives it compatibility with the basic dyes.

U.S. Pat. No. 4,391,968 [4] describes a process for preparing polyamides having an affinity with basic dyes by incorporating, in the reaction medium, in addition to the monomers acting as precursors to the amide patterns, a specific dicarboxylic monomer and a specific dicarboxylic sulfonic acid salt.

However, these processes have the disadvantage of modifying the chemical structure of the polyamides, which can in particular negatively influence the mechanical strength of the fibers developed using these polyamides.

Some authors propose modifying the surface of the aramid fiber by a suitable treatment in order to promote the bonding of the dyes. Thus, Advances in Textiles Technology, pages 6-7 [5], describes a process consisting of subjecting aramid fibers to a plasma treatment, so as to generate activation sites, where the dyes will then be capable of bonding. However, this type of treatment degrades the mechanical properties of the fibers, which is hardly beneficial when these fibers are intended to be used in fields requiring excellent properties in terms of resistance to fire and chemical products.

Thus, there is a real need for a process for modifying aramid fibers that does not have the disadvantages of the prior art, and in particular:
that does not modify the chemical structure of the fibers and, consequently, the physicochemical properties thereof;
that generates fibers capable of being dyed by all sorts of dyes, namely, for example, cationic dyes and anionic dyes.

### DESCRIPTION OF THE INVENTION

Thus, the invention firstly relates to a process for modifying aramid fibers so as to improve their capacity to be dyed, including the following steps:

a) a step of treating said fibers so as to reduce the glass transition temperature Tg thereof to a value Tg₁, in which Tg₁ is lower than Tg;

b) a step of contacting said fibers thus treated with a solution including nanoparticles at a temperature above or equal to Tg₁.

It should be specified that, according to the invention, the term “aramid fibers” is generally used to refer to fibers containing a synthetic polyamide chain, in which at least 85% of the amide groups are directly bound to aromatic groups, of which the main repetitive pattern has the following formula:

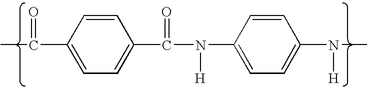

Derivative forms of this pattern may exist with substitutions on the aromatic cycles and a substitution of the hydrogen of the —NH— group.

It should be specified that, according to the invention, the term “nanoparticles” is generally used to refer to particles having a diameter ranging from 1 to 500 nm, preferably 8 to 30 nm, and even more preferably from 10 to 20 nm.

Aramid fibers include, in the untreated state, crystalline zones in the majority and amorphous zones in the minority. Due to this very strong crystallinity, aramid fibers are not really disposed to enable the diffusion and bonding of compounds.

It should be specified that the glass transition temperature is an intrinsic property of the fibers, which corresponds in particular to the temperature at which the mobility of the chains is significantly increased, thus generating an increase in the free volume.

By reducing the glass transition temperature of the aramid fibers from Tg to Tg₁ in step a), it is thus possible, when the fibers are brought to a temperature greater than or equal to Tg₁, increase the mobility of the chains, and consequently open the amorphous zones at a lower temperature (for example, the glass transition temperature can be reduced from around 200° C. to around 120° C.) in step b). This lower temperature is less aggressive with respect to the dyes and makes it possible to carry out the process at lower temperatures.

Step a) may consist of reducing the glass transition temperature so that the glass transition temperature Tg₁ is in a range from 100 to 150° C.

It should be specified that the reduction in the glass transition temperature can easily be measured by a person skilled in the art using DCS (Differential Scanning Calorimetry) techniques in a sealed capsule or DMA (Dynamic Mechanical Analysis) techniques.

The treatment intended to reduce the glass transition temperature (step a) of the fibers may consist of placing them in contact with a solvent chosen from benzyl alcohol, cyclohexanone, dimethylformamide, dimethylacetamide, dimethylsulfoxide, acetophenone, benzaldehyde and mixtures thereof.

Once the reduction in the glass transition temperature has been obtained by the treatment of step a), the aramid fibers are placed in contact with a solution including nanoparticles, at a temperature greater than or equal to the glass transition temperature Tg₁. By working at a temperature greater than or equal to Tg₁, namely the glass transition temperature obtained at the end of step a), fibers are obtained with an increased mobility of the polymer chains and, consequently, an opening of the amorphous zones, in which the nanoparticles contained in the solution can thus be incorporated in the free spaces formed by the opening of the amorphous zones.

The nanoparticles incorporated may be of various types.

A first embodiment may involve nanoparticles not containing a dye, but that optionally have groups capable of bonding at the surface of the aramid fibers, for example, by ionic bonds or weak bonds, such as hydrogen bonds.

These nanoparticles may be porous, in which case they can receive, in their pores, one or more dyes. As examples of such nanoparticles, nanoparticles of SiO₂, TiO₂, ZnO, Al₂O₃ and Fe₃O₄ can be cited.

These nanoparticles may comprise groups capable of bonding, for example by an ionic bond or by weak bonds such as hydrogen bonds, to dyes or to particles containing these dyes. As examples, it is possible to cite nanoparticles of SiO₂ comprising, at their surface, —OH functions capable of bonding, for example, by the formation of hydrogen bonds, with dyes comprising functions capable of creating this type of bond, such as rhodamine, fluoroescein, Diamix dyes. It is also possible to cite nanoparticles including, at their surface, acid functions, such as —CO₂H, which will be capable of bonding with cationic dyes and/or including, at their surface, basic functions, such as amine functions, which will be capable of binding with anionic dyes. As examples of such nanoparticles, it is possible to cite nanoparticles of SiO₂, TiO₂, ZnO, Al₂O₃ and Fe₃O₄ that have been subjected to a functionalisation enabling the grafting of acid or basic functions using techniques well known to a person skilled in the art. In this case, the nanoparticles can be defined as adhesion promoters.

A second embodiment may involve nanoparticles comprising a dye, which dye has generally been previously incorporated in the nanoparticles. As examples, it is possible to cite particles including a SiC₂ shell and a core consisting of the dye, or a dye dispersed in a nanoparticle or a dye provided in the form of an external crown on the nanoparticle, such as a fluorescent dye. The advantage of this type of nanoparticles is that it is possible to incorporate any type of dye, in particular dyes not having, due to their functions, an intrinsic capacity to bond with the aramid fibers, in particular anionic dyes, or not having good temperature resistance.

The nanoparticles may be prepared by a sol-gel process.

In the context of the invention, the sol-gel process generally consists of preparing, in a first step, a solution including the precursor(s) of said nanoparticles in the molecular state (organometallic compounds, metal salts) and optionally the dye, when the nanoparticles contain the latter.

In a second step, the aforementioned solution is hydrolyzed, so as to form a dispersion of small oxide particles. Then, a centrifugation is performed so as to recover the nanoparticles formed.

The molecular precursors may be in the form of inorganic salts, such as halogenides and nitrates. They may also be in the form of organometallic compounds, such as alcoxides.

In particular, when the nanoparticles are partially or entirely constituted by SiO₂, the molecular precursor can be a silicon alcoxide, such as tetraethoxysilicate Si(OC₂H₅)₄, or tetramethoxysilicate Si (OCH₃) 4.

The organic solvent may be an aliphatic monoalcohol, such as ethanol.

Steps a) and b) of the process of the invention may be implemented simultaneously, in particular when the fibers are placed in contact with a solution including both an agent capable of reducing the glass transition temperature and nanoparticles.

Once step b) has been implemented, the process of the invention advantageously includes a step c) of reducing the temperature of the fibers to a value below Tg₁. From a practical perspective, this step of reducing the temperature can consist of separating the fibers of the solution of step b), so as to bring the fibers to room temperature. This step of reducing the temperature is performed by closing the amorphous zones and mechanically containing the nanoparticles within the aramid fibers. This “mechanical” containment is added to a possible chemical bonding, if the nanoparticles used have surface chemical groups compatible with the aramid fibers, which chemical bonding can involve weak or strong interactions.

After the step of reducing the temperature, the process can also include, simultaneously or after step c), a step d) of rinsing the fibers, making it possible in particular to remove all of the reagents that have not reacted, such as the nanoparticles not bonded to the fibers or the other constituents of the solution used in step b).

The process described above is a process intended to improve the capacity of the aramid fibers to be dyed. It can therefore be implemented in the context of a dyeing process.

Thus, the invention relates, secondarily, to a process for dyeing aramid fibers, including:
a step of implementing the aramid fiber modification process as defined above;
optionally a step of placing said fibers in contact with a dye, in particular when the nanoparticles do not contain a dye.

It should be specified that these two steps can be performed concomitantly, if the aramid fibers are placed in contact with a solution simultaneously containing an agent capable of reducing the glass transition temperature, nanoparticles and a dye.

In this case, the dyeing process will ultimately include a step intended to reduce the reaction medium to a value below Tg₁, so as to close the amorphous zones and contain the nanoparticles and the dye inside the fiber, thus enabling the color to be fixed.

If nanoparticles including a dye are bonded to the aramid fibers, the step of contact with a dye after the step of bonding said nanoparticles is not necessary. The advantage of using nanoparticles containing a dye is that it is possible to incorporate any type of dye, such as fluorescent dyes, and in particular to protect it.

If the nanoparticles do not contain a dye, the aramid fibers must be placed in contact with a dye, and the nanoparticles act as an adhesion promoter.

The dye can be bonded to the nanoparticles by a sol-gel process, either directly or by means of particles containing said dye. The nanoparticles bonded to the aramid fibers act as a bonding point and/or a seed for the growth of the sol-gel material containing the dye. By growth of the latter, it is thus possible to cover a large surface of the fiber. In this way, it is also possible to graft a large number of dyes on these nanoparticles.

The dye can be bonded to the nanoparticles by means of particles containing dyes or themselves constituting dyes, with the bonding being achieved by ionic, weak or covalent interactions. Such particles may be resin particles, of microscopic size, trapping pigments or dyes.

The dye may be bonded to the nanoparticles by occupying the porosity thereof, and the dye may then be diffused over the fibers.

Thus, the technical innovation is to successfully bond nanoparticles to aramid fibers and to then use these nanoparticles as a dye (the dyes being contained in the nanoparticles), either as a bonding point or as dyes in molecular form or as a material formed by a sol-gel process that contains dyes.

Aside from the aforementioned aspect, the nature of the nanoparticles used can make it possible to obtain other beneficial functions. In particular, it has been demonstrated that dyes bonded to certain fibers can be relatively non-resistant to UV. Thus, the use of nanoparticles with good UV absorption (such as TiO₂ nanoparticles) makes it possible to limit the degradation of the dye of the dyed fiber over time.

### DETAILED DESCRIPTION OF SPECIFIC EMBODIMENTS

### Example 1

This example shows a process for preparing aramid fibers with SiO₂ nanoparticles, on which it will subsequently be possible to bond a dye.

In a first step, a bath is prepared by mixing 3.4 mL of a solution of SiO₂ nanoparticles (having a diameter of 12.5 nm) at 0.1% by weight, 15 mL of benzyl alcohol, to which 150 mL of deionized water are added. The dye bath pH is adjusted to a value of 3.5 to 4.

The bath thus obtained is then placed in contact with 5 g of an aramid textile, and everything is heated to 120° C. for 60 minutes.

The aramid textile is then recovered from the bath and rinsed in cold water.

The fibers thus obtained are photographed by scanning electron microscopy and thus show nanoparticles bonded to them.

### Example 2

This example shows a process of dyeing aramid fibers by means of nanoparticles incorporated therein, which nanoparticles are SiO₂ nanoparticles including a dye, in this particular case rhodamine-B-isocyanate (RBITC).

In a first step, a first solution (solution A) is prepared by mixing 30 mL of ethanol, 4.46 mL of tetraethoxysilane and 0.2 mg of rhodamine-B-isocyanate, which mixture is agitated for 1 hour.

In a second step, a second solution is prepared (solution B) by mixing 30 mL of ethanol, 0.65 mL of a solution with 30% ammonium hydroxide and 9.8 mL of deionized water.

Solution B is added to solution A at room temperature, and the resulting mixture is agitated for 15 hours, then neutralized.

The mixture is then centrifuged and washed with ethanol until the supernatant is clear. The particles formed have a diameter of 20 nm, measured with a Zetasizer Nano ZS apparatus.

To incorporate these dyed nanoparticles in the fibers, the same procedure as in example 1 is used.

### Example 3

This example shows a process of dyeing aramid fibers by means of nanoparticles incorporated therein, which nanoparticles are SiO₂ nanoparticles including a commercial dye.

In a first step, a first solution (solution A) is prepared by mixing 3 mL of ethanol, 1 mL of tetraethoxysilane and 197.4 mg of commercial dye, and the mixture is agitated for 10 minutes, then 0.8 mL of an ammonium hydroxide at 1 mol/L is added to this solution.

In a second step, a second solution is prepared (solution B) by mixing 30 mL of ethanol and 0.6 mL of tetraethoxysilane. Solution A is added to solution B dropwise and they are agitated for 3 hours. 7.2 mL of tetraethoxysilane and 4.7 mL of an ammonium hydroxide solution at 1 mol/L are added to the resulting mixture. It is agitated for 15 minutes.

The mixture is then centrifuged and washed with ethanol three times.

The particles formed have a diameter of 300 nm, measured with a Zetasizer Nano ZS apparatus.

A fluorescence spectrum showed a shift of the fluorescence peak of the dye before and after coating, which proves that the dye was incorporated in the SiO₂ particles.

To incorporate these dyed nanoparticles in the fibers, a procedure similar to that described in example 1 is performed.

### Example 4

This example shows a process of dyeing aramid fibers by means of nanoparticles incorporated therein, which nanoparticles are SiO₂ nanoparticles including a commercial dye.

An emulsion is prepared by mixing 1.77 g of Triton-X-100, 7.7 mL of cyclohexane, 1.6 mL of n-hexanol and 3.34 mL of deionized water, and said emulsion is agitated for 15 minutes. 0.04 mL of a solution at 1 mol/L containing the dye is added to the emulsion, followed by agitation for 5 minutes, and the addition of 0.05 mL of tetraethoxysilane and another agitation for 30 minutes. Finally, 0.1 mL of ammonium hydroxide is added and it is agitated for 24 hours at room temperature. The emulsion is then destabilized by the addition of ethanol, then subjected to centrifugation followed by washing with ethanol, then deionized water.

The particles obtained have a diameter of 100 nm, measured with a Zetasizer Nano ZS apparatus. They are redispersed well in water.

To incorporate these dyed nanoparticles in the fibers, a procedure similar to that described in example 1 is performed.

### Example 5

This example consists, in a first step, of the preparation of nanoparticles as in example 2. The nanoparticles are then dispersed in 31 mL of ethanol. 26.8 mL of tetraethoxysilane are added to the resulting mixture.

A textile prepared by SiO₂ nanoparticles (with a diameter of 12.5 nm) is soaked in the mixture obtained, in the presence of benzyl alcohol according to the conditions described in example 1.

It is agitated at room temperature for 1 hour.

Simultaneously, a solution B is produced by mixing 32 mL of deionized water and 12 mL of a hydrochloric acid solution with a pH of 2. The solution B is then added to the previous mixture and everything is brought to reflux at 70° C. for 4 hours. Once it has returned to room temperature, it is rinsed with cold water.

1. Process for modifying aramid fibers so as to improve their capacity to be dyed, characterized in that it includes the following steps:
a) a step of treating said fibers so as to reduce the glass transition temperature Tg thereof to a value Tg₁, in which Tg₁ is lower than Tg;
b) a step of contacting said fibers thus treated with a solution including nanoparticles at a temperature above or equal to Tg₁.

2. Process according to claim 1, characterized in that steps a) and b) are implemented simultaneously.

3. Process according to claim 1 or 2, characterized in that the treatment step a) consists of placing said fibers in contact with a solvent chosen from benzyl alcohol, cyclohexanone, dimethylformamide, dimethylacetamide, dimethylsulfoxide, acetophenone, benzaldehyde and mixtures thereof.

4. Process according to any one of the previous claims, characterized in that the nanoparticles do not include a dye, and have groups capable of bonding at the surface of the aramid fibers.

5. Process according to any one of the previous claims, characterized in that the nanoparticles are porous.

6. Process according to claim 4, characterized in that the nanoparticles comprise groups capable of bonding by ionic bonds or by weak bonds with dyes or with particles containing said dyes.

7. Process according to claim 6, characterized in that the nanoparticles are SiO₂ nanoparticles, comprising —OH functions at their surface.

8. Process according to any one of claims 1 to 3, characterized in that the nanoparticles include a dye.

9. Process according to claim 8, characterized in that the nanoparticles including a dye contain an SiO₂ shell and a core consisting of the dye.

10. Process according to any one of the previous claims, characterized in that the nanoparticles are prepared by a sol-gel process.

11. Process according to any one of the previous claims, characterized in that it includes, after step b), a step c) of reducing the temperature of the fibers to a value below Tg₁.

12. Process according to claim 11, characterized in that it also includes, simultaneously or after step c), a step d) of rinsing the fibers.

13. Process for dyeing aramid fibers, characterized in that it includes:
a step of implementing the aramid fiber modification process as defined in any one of claims 1 to 12;
optionally a step of placing said fibers in contact with a dye, in particular when the nanoparticles do not contain a dye.

14. Dyeing process according to claim 13, characterized in that the dye is bonded to the nanoparticles by a sol-gel process, either directly or by means of particles containing said dye.
